(19) United States
(12) Patent Application Publication
(10) Pub. No.: US 2011/0138307 A1
(43) Pub. Date: Jun. 9, 2011

(54) PUBLISHING CLIENT DEVICE USAGE DATA

(75) Inventor: Omid Eizadi, Belmont, CA (US)

(73) Assignee: Microsoft Corporation, Redmond, WA (US)

(21) Appl. No.: 12/634,314

(22) Filed: Dec. 9, 2009

(51) Int. Cl. G06F 15/16; G06F 21/00; G06F 3/01

(52) U.S. Cl. 715/760; 709/217; 726/4; 709/227

(57) ABSTRACT

Publishing client device usage data is described. In embodiments, usage data is received that corresponds to one or more device applications on a client device when the one or more device applications are used at the client device. A request for the usage data can be received from a requesting client device, and a portable code module is generated that includes the usage data. The portable code module that includes the usage data is then communicated to the requesting client device that can execute the portable code module to display the usage data.

### BACKGROUND

Portable devices are increasingly more common and mobile, such as laptop computers, tablet PCs, ultra-mobile PCs, as well as other mobile data, messaging, and/or communication devices. Wireless devices are popular due to their portability, convenience, and ease of use. Wireless devices have increasingly become part of everyday life, providing multiple functions and services such as wireless communication, location-based services, email, media content playback, electronic calendaring, Web-based applications, and many other functions and services that are available whenever convenient for a user.

### SUMMARY

This summary is provided to introduce simplified concepts of publishing client device usage data that are further described below in the Detailed Description. This summary is not intended to identify essential features of the claimed subject matter, nor is it intended for use in determining the scope of the claimed subject matter.

Publishing client device usage data is described. In embodiments, usage data is received that corresponds to one or more device applications on a client device when the one or more device applications are used at the client device. A request for the usage data can be received from a requesting client device, and a portable code module is generated that includes the usage data. The portable code module that includes the usage data is then communicated to the requesting client device that can execute the portable code module to display the usage data.

In other embodiments, the usage data can be filtered based on user preferences that are associated with the client device and/or a user of the client device. Types of the usage data that is received can be specified by user preferences and/or the usage data can be received to include identification of users that are permitted to request access to the usage data. The portable code module can be generated to include filtered usage data according to the user preferences. The usage data that corresponds to the one or more device applications can pertain to any one of a Web page displayed for viewing at the client device, media content played back at the client device, an instant messaging session initiated at the client device, a current location of the client device, and/or an on-line presence of a user that is associated with the client device.

### BRIEF DESCRIPTION OF THE DRAWINGS

Embodiments of publishing client device usage data are described with reference to the following drawings. The same numbers are used throughout the drawings to reference like features and components:

FIG. 1 illustrates an example system in which embodiments of publishing client device usage data can be implemented.

FIG. 2 illustrates an example portable device in which embodiments of publishing client device usage data can be implemented.

FIG. 3 illustrates example method(s) of publishing client device usage data in accordance with one or more embodiments.

FIG. 4 illustrates various components of an example device that can implement embodiments of publishing client device usage data.

### DETAILED DESCRIPTION

Embodiments of publishing client device usage data provide techniques to collect applications usage data, such as on a client device or wireless device, when a user at a device uses or initiates a device application. The applications usage data can be communicated to a data service that filters the usage data based on user preferences, such as types of usage data at a device that a user authorizes or allows to be published. A Web service can generate a portable code module that includes the usage data, and the portable code module can then be communicated to a requesting client device that executes the portable code module to display the usage data.

While features and concepts of the described systems and methods for publishing client device usage data can be implemented in any number of different environments, systems, and/or various configurations, embodiments of publishing client device usage data are described in the context of the following example systems and environments.

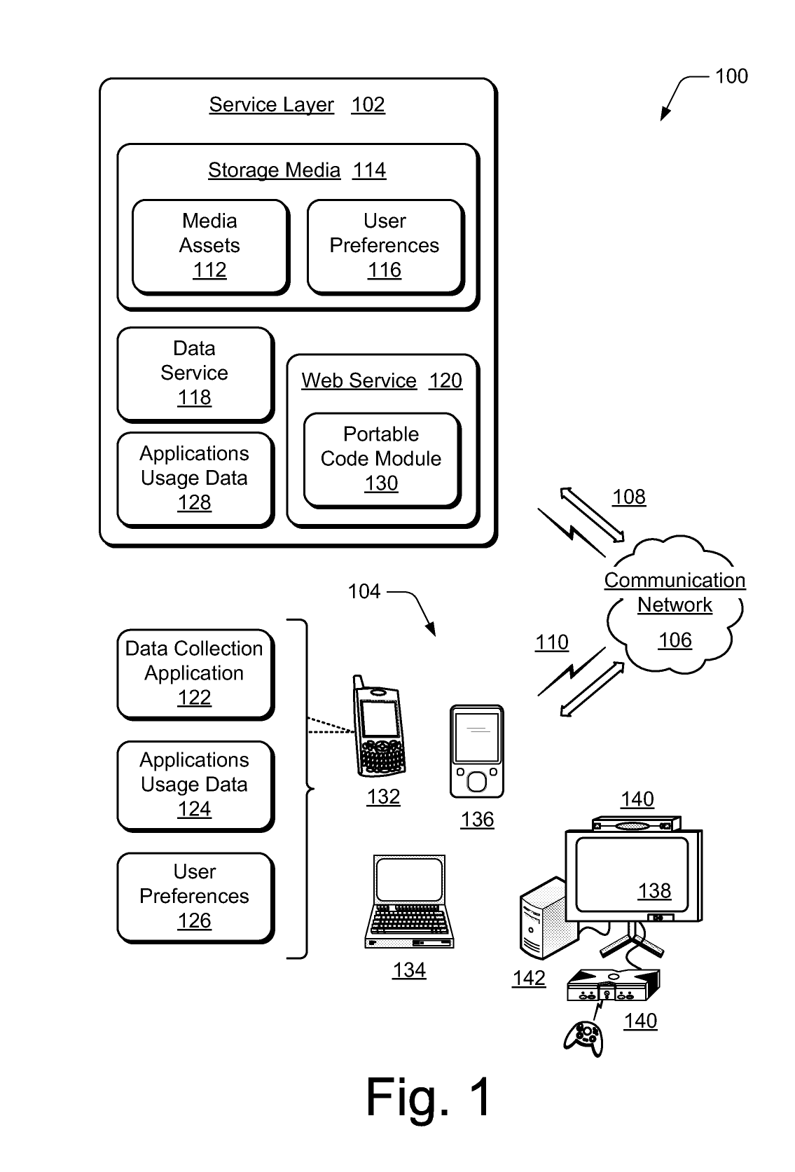

FIG. 1 illustrates an example system 100 in which various embodiments of publishing client device usage data can be implemented. In this example, system 100 includes a service layer 102 that can be configured to communicate or otherwise provide media assets and data to any number of various client devices 104 via a communication network 106. Some of the client devices 104 may also be referred to as portable devices and/or user devices. The client devices 104 can include wired and/or wireless devices, some of which may be implemented as components in a client system of a media asset distribution system.

The communication network 106 can be implemented to include a broadcast network, an IP-based network 108, and/or a wireless network 110 that facilitates media asset distribution and data communication between the service layer 102 and any number of the various devices. The communication network 106 can also be implemented as part of a media asset distribution system using any type of network topology and/or communication protocol, and can be represented or otherwise implemented as a combination of two or more networks. The communication network may also include a mobile operator network that is managed by a communication service provider, such as a cell-phone provider and/or Internet service provider, to facilitate mobile data and/or voice communications for any type of a wireless device or mobile phone (e.g., cellular, VoIP, WiFi, etc.).

Service layer 102 can include one or more media content servers that are implemented to communicate, or otherwise distribute, media assets 112 and/or other data to any number of the various client devices. In this example system 100, service layer 102 includes storage media 114 to store or otherwise maintain various data and media assets, such as the media assets 112 and user preferences 116. The storage media 114 can be implemented as any type of memory, random access memory (RAM), a nonvolatile memory such as flash memory, read only memory (ROM), and/or other suitable electronic data storage.

The media assets 112 can include any type of audio, video, and/or image data received from any type of media content or data source. As described throughout, media assets can include music (e.g., digital music files of songs), television programming, movies, on-demand media assets, interactive games, network-based applications, and any other audio, video, and/or image data (e.g., to include program guide data, user interface data, advertising content, closed captions data, content metadata, search results and/or recommendations, etc.).

The user preferences 116 correlate to the various client devices 104, and indicates types of application usage data at a client device that a user authorizes or allows to be published. The user preferences 116 can also indicate specific users who are permitted or allowed access to the application usage data that corresponds to device applications on a client device when the device applications are used at the client device. The user preferences 116 can include an identifier of a client device when registered with the service layer 102. An identifier can include any one or combination of a user identifier, a device identifier, a phone identifier, a phone number, and any other identifier that can be utilized to correlate a user and/or a client device.

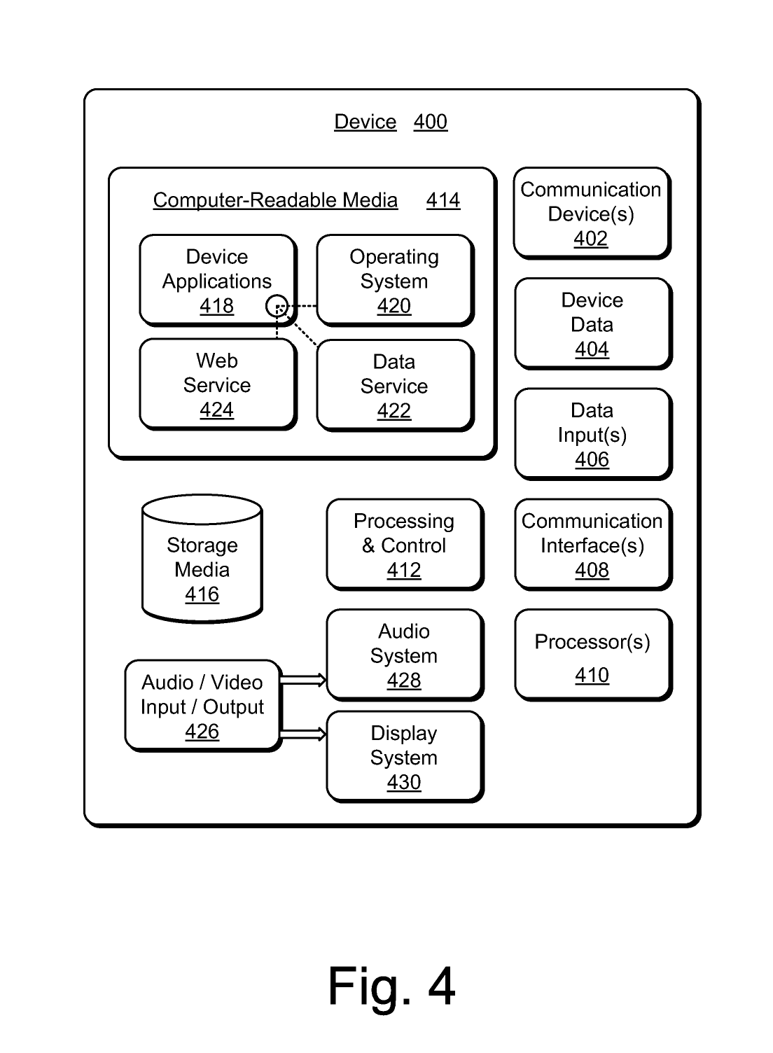

The service layer 102 includes a data service 118 and a Web service 120 that can each be implemented as computer-executable instructions and executed by processors to implement the various embodiments and/or features described herein. In addition, the service layer 102 can be implemented with any number and combination of differing components as further described with reference to the example device shown in FIG. 4. The data service 118 and/or the Web service 120, as well as other functionality described to implement embodiments of publishing client device usage data, can also be provided as a service apart from the service layer 102 (e.g., on a separate server or by a third party service), or as a distributed service.

Any of the various client devices 104 can include a data collection application 122 that is implemented to track and/or collect applications usage data 124, such as when a user at a client device 104 uses or initiates a device application. For example, the data collection application 122 can collect applications usage data 124 pertaining to various device applications, such as a media player application, a Web browser, an instant messaging client, a location tracking module, a presence management module, and any other type of application that may be initiated for use on a client device.

In implementations, the usage data may be collected when an application writes information related to current usage (e.g., currently playing, current on-line status, etc.) to a file, which is then read by the data collection application 122. Alternatively or in addition, the data collection application can be implemented to interface directly with the various device applications via an application programming interface (API) to retrieve the usage data. The applications usage data 124 can include data that pertains to current or recent activity on a client device 104 including, but not limited to, a Web page displayed for viewing at the device, media content played back at the device, an instant messaging session initiated at the device, a current location of the device, or an on-line presence of a user that is associated with the device.

A media player application at a client device 104 can provide the data collection application 122 with information related to multimedia content that is being played back at the client device. For audio content, the usage data may include an artist and/or a song title. For video content, the usage data may include a title of a movie, TV show, or other metadata pertaining to video content. A Web browser application at the client device 104 can provide the data collection application 122 with Web-related information, such as a Web site that is displayed for viewing and/or a history of visited Web sites. An instant messaging client at the client device 104 can provide the data collection application 122 with information related to instant messaging sessions, such as a list of messaging participants and an on-line status of a user that is associated with the client device.

A location tracking application or module at the client device 104 can provide the data collection application 122 with information related to a current location of the client device, such as via a GPS system, or based on a current cell tower via which the client device is linked for wireless communication. A presence management application or module at the client device 104 can provide the data collection application 122 with information related to a current on-line presence of the user. This may include an indication that the user is on-line or off-line and, if the user is on-line, whether the user is active or idle and/or a status with respect to services or applications that are accessed on the client device.

A client device 104 can also include user preferences 126 that indicate the types of application usage data that a user authorizes or allows to be published. The user preferences 126 can also indicate specific users who are permitted or allowed access to the application usage data 124 that corresponds to the device applications initiated for use on the client device. In an embodiment, the data collection application 122 communicates the applications usage data 124 to the service layer 102 as the usage data is collected on the client device 104. The data collection application 122 can communicate the usage data, or updated usage data, to the service layer 102 as application use and/or changes are detected. For example, the client device 104 can communicate updated usage data when a new media file is played back, a new Web page is browsed, the client device moves to a new location, and/or when an on-line status of a user changes (e.g., off-line to on-line, and vice-versa).

The data service 118 at the service layer 102 is implemented to receive applications usage data 128 from the various client devices 104. In an embodiment, the applications usage data 128 corresponds to device applications that are used at a client device. The data service 118 can also be implemented to filter the usage data 128 based on the user preferences 116 that are associated with a client device. In an implementation, the data service 118 can encapsulate the applications usage data 128 as a Web service response and communicate the usage data to the Web service 120.

The Web service 120 at the service layer 102 can receive the applications usage data 128 from the data service 118 and generate a portable code module 130 that includes the usage data. A portable code module can be implemented as a portable block of executable program code that may be installed and executed within an HTML-based Web page without the need for additional compilation. A portable code module may be referred to as a Web widget which is also known by various other terms, such as a gadget, a module, a snippet, or a webjit that can be implemented in dynamic HTML. In embodiments, the Web service 120 can generate the portable code module 130 to include filtered usage data when the applications usage data 128 is filtered by the data service 118. The Web service 120 can also generate a Web page that includes the portable code module 130.

The Web service 120 can receive a request for the applications usage data, such as from a different client device than the device on which the usage data was collected. For example, a user at a client computer can request to view the current usage data 128 that is collected from a wireless client device, which in an embodiment, may be pending authorization of the user to allow access to the usage data. The Web service 120 can then communicate the portable code module 130 that includes the usage data 128 to the requesting client device that is configured to execute the portable code module and display the usage data. Alternatively or in addition, the Web service 120 can communicate a Web page that includes the portable code module 130 to the requesting client device for display of the Web page.

In this example system 100, wireless devices can include any type of device implemented to receive and/or communicate wireless data, such as any one or combination of a mobile phone 132 (e.g., cellular, VoIP, WiFi, etc.), a portable computer device 134, a media device 136 (e.g., a personal media player, portable media player, etc.), and/or any other wireless device that can receive media assets in any form of audio, video, and/or image data. A client system can include a respective client device and display device 138 that together render or playback any form of audio, video, and/or image media content and media assets.

The display device 138 can be implemented as any type of a television, high definition television (HDTV), LCD, or similar display system. A client device can be implemented as any one or combination of a television client device 140 (e.g., a television set-top box, a digital video recorder (DVR), etc.), a computer device 142, a gaming system 144, an appliance device, an electronic device, and/or as any other type of client device or user device that may be implemented to receive media assets in any form of audio, video, and/or image data in a media asset distribution system.

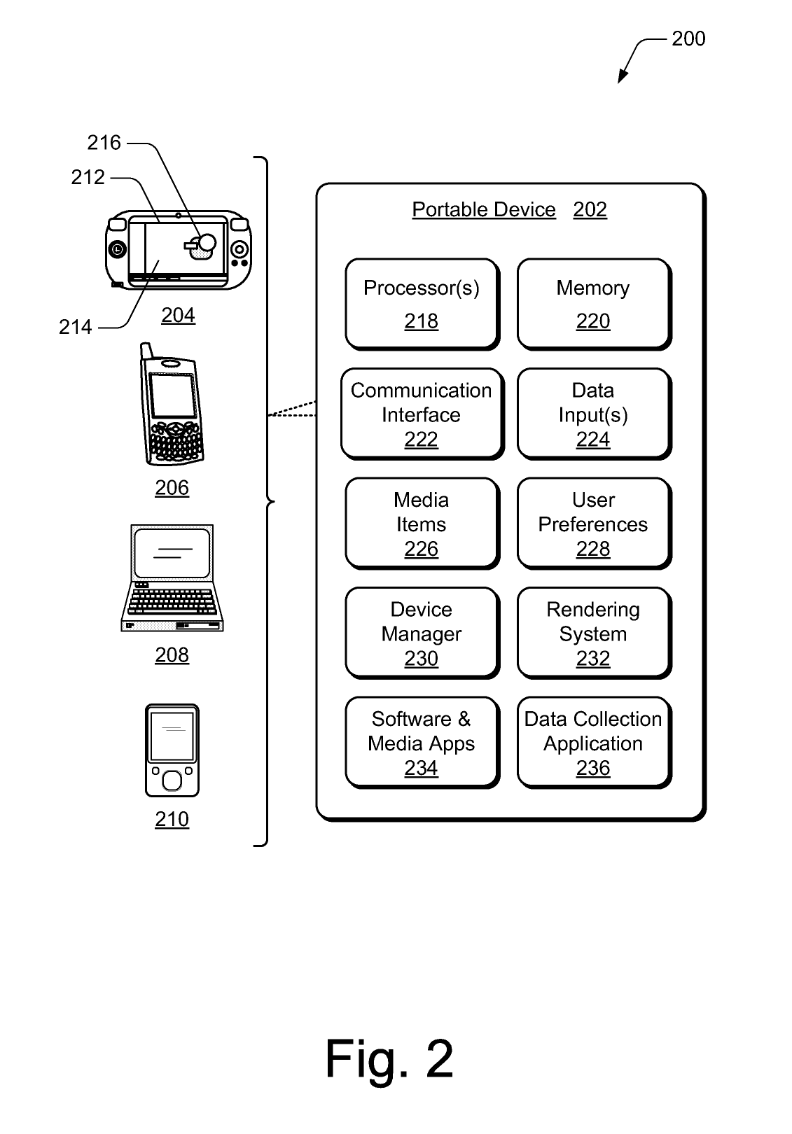

Any of the various client devices 104 can be implemented with one or more processors, communication components, memory components, signal processing and control circuits, and a media asset rendering system. Further, any of the wireless devices and/or other client devices can be implemented with any number and combination of differing components as further described with reference to the example device shown in FIG. 2, and with reference to the example device shown in FIG. 4. A user device may also be associated with a user (i.e., a person) and/or an entity that operates the device such that a user device describes logical devices that include users, software, and/or a combination of devices.

Any of the client devices 104 can communicate with service layer 102 via a two-way data communication link of the communication network 106. It is contemplated that any one or more of the arrowed communication links, along with communication network 106, facilitate two-way data communication, such as from a client device 104 to the service layer 102 and vice-versa.

FIG. 2 illustrates an example system 200 in which various embodiments of publishing client device usage data can be implemented. Example system 200 includes a portable device 202 (e.g., a wired and/or wireless device) that can be any one or combination of a mobile personal computer 204, a personal digital assistant (PDA), a mobile phone 206 (e.g., cellular, VoIP, WiFi, etc.) that is implemented for data, messaging, and/or voice communications, a portable computer device 208 (e.g., a laptop computer, a laptop computer with a touch-screen, etc.), a media device 210 (e.g., a personal media player, portable media player, etc.), a gaming device, an appliance device, an electronic device, and/or any other type of portable device that can receive, display, and/or communicate data in any form of audio, video, and/or image data.

Each of the various portable devices (e.g., also referred to as client devices and/or user devices) can include an integrated display and/or an integrated touch-screen, as well as selectable input controls via which a user can input data and/or selections. For example, mobile personal computer 204 includes an integrated touch-screen 212 on which a user interface 214 can be displayed that includes displayable objects and/or user interface elements 216, such as any type of an icon, image, graphic, text, selectable button, user-selectable control, menu selection, map element, and/or any other type of user interface displayable feature or item.

Any of the various portable devices described herein can be implemented with one or more sensors, processors, communication components, data inputs, memory components, storage media, processing and control circuits, and/or a content rendering system. Any of the portable devices can also be implemented for communication via communication networks that can include any type of a data network, voice network, broadcast network, an IP-based network, and/or a wireless network that facilitates data, messaging, and/or voice communications. A portable device can also be implemented with any number and combination of differing components as described with reference to the example device shown in FIG. 4. A portable device may also be associated with a user (i.e., a person) and/or an entity that operates the device such that a portable device describes logical devices that include users, software, and/or a combination of devices.

In this example, portable device 202 includes one or more processors 218 (e.g., any of microprocessors, controllers, and the like), a memory 220, a communication interface 222 for data, messaging, and/or voice communications, and data inputs 224 to receive media items 226 and/or media content. Media items can include any type of email messages, text messages, digital photos, song selections, and the like. Media content (e.g., to include recorded media content) can include any type of audio, video, and/or image data received from any media content or data source, such as messages, television media content, music, video clips, data feeds, interactive games, network-based applications, and any other content.

The user preferences 228 indicate the types of application usage data that a user authorizes or allows to be published. The user preferences 228 can also indicate specific users who are permitted or allowed access to the application usage data that corresponds to the device applications initiated for use on the device. Portable device 202 is implemented with a device manager 230 that includes any one or combination of a control application, software application, signal processing and control module, code that is native to the particular device, and/or a hardware abstraction layer for the particular device. Portable device 202 also includes a rendering system 232 to render user interfaces and user interface elements for display on any of the portable devices. The rendering system 232 is also implemented to receive and render any form of audio, video, and/or image data received from any media content and/or data source.

Portable device 202 includes various software and/or media applications 234 that may incorporate components and/or modules that can be processed or otherwise executed by the processors 218. The media applications 234 can include a music and/or video player, a Web browser, an email application, a messaging application, a photo viewer, and the like. The portable device 202 also includes a data collection application 236 to implement various embodiments of publishing client device usage data as described herein. Features and aspects of the data collection application 236 are described with reference to the data collection application 122 shown in FIG. 1 at a client device 104.

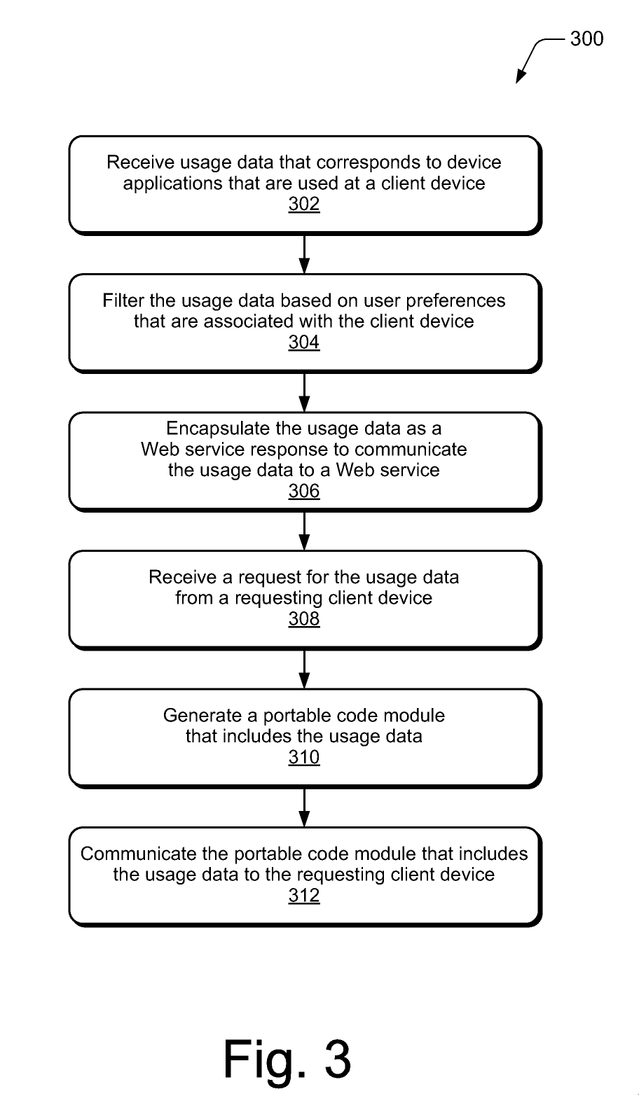

Example method 300 is described with reference to FIG. 3 in accordance with one or more embodiments of publishing client device usage data. Generally, any of the functions, methods, procedures, components, and modules described herein can be implemented using hardware, software, firmware, fixed logic circuitry, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The methods may also be practiced in a distributed computing environment by processing devices that are linked through a communication network. In a distributed computing environment, computer-executable instructions may be located in both local and remote computer storage media and/or devices. Further, the features described herein are platform-independent and can be implemented on a variety of computing platforms having a variety of processors.

FIG. 3 illustrates example method(s) 300 of publishing client device usage data. The order in which the method blocks are described are not intended to be construed as a limitation, and any number of the described method blocks can be combined in any order to implement a method, or an alternate method.

At block 302, usage data is received that corresponds to device applications that are used at a client device. For example, the data service 118 at the service layer 102 receives the applications usage data 128 from a client device 104. The usage data corresponds to device applications that are used at the client device, such as any one of a Web page displayed for viewing at the client device, media content played back at the client device, an instant messaging session initiated at the client device, a current location of the client device, and/or an on-line presence of a user that is associated with the client device.

At block 304, the usage data is filtered based on user preferences that are associated with the client device. For example, the data service 118 at the service layer 102 filters the applications usage data 128 based on user preferences 116 that are associated with the client device and/or a user of the client device. Types of the usage data that is received can be specified by the user preferences and/or the usage data can be received to include identification of users that are permitted to request access to the usage data.

At block 306, the usage data is encapsulated as a Web service response to communicate the usage data to a Web service. For example, the data service 118 at the service layer 102 encapsulates the applications usage data 128 (e.g., or filtered usage data) for communication to the Web service 120. At block 308, a request for the usage data is received from a requesting client device. For example, a user initiates a request for the applications usage data 128 via a client device 142 that communicates the request for the usage data to the service layer 102.

At block 310, a portable code module is generated that includes the usage data. For example, the Web service 120 at service layer 102 (or alternatively, an independent Web service) generates the portable code module 130 that includes the usage data, or filtered usage data. In an implementation, the Web service 120 generates a Web page that includes the portable code module 130, and the Web page can be communicated to the requesting client device for display of the Web page.

At block 312, the portable code module that includes the usage data is communicated to the requesting client device. For example, the Web service 120 at service layer 102 initiates communicating the portable code module 130 that includes the applications usage data 128 (e.g., or filtered usage data) to the requesting client device that executes the portable code module to display the usage data.

FIG. 4 illustrates various components of an example device 400 that can be implemented as any type of device and/or service layer as described with reference to FIGS. 1 and 2 to implement embodiments of publishing client device usage data. In embodiments, device 400 can be implemented as any one or combination of a wired and/or wireless device, as any form of television client device (e.g., television set-top box, digital video recorder (DVR), etc.), consumer device, computer device, server device, portable computer device, user device, communication device, video processing and/or rendering device, appliance device, gaming device, electronic device, and/or as any other type of device. Device 400 may also be associated with a user (i.e., a person) and/or an entity that operates the device such that a device describes logical devices that include users, software, firmware, and/or a combination of devices.

Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include any type of audio, video, and/or image data. Device 400 includes one or more data inputs 406 via which any type of data, media content, and/or inputs can be received, such as user-selectable inputs, messages, music, television media content, recorded video content, and any other type of audio, video, and/or image data received from any content and/or data source.

Device 400 also includes communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like) which process various computer-executable instructions to control the operation of device 400 and to implement embodiments of publishing client device usage data. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 416.

Computer-readable media 414 provides data storage mechanisms to store the device data 404, as well as various device applications 418 and any other types of information and/or data related to operational aspects of device 400. For example, an operating system 420 can be maintained as a computer application with the computer-readable media 414 and executed on processors 410. The device applications 418 can include a device manager (e.g., a control application, software application, signal processing and control module, code that is native to a particular device, a hardware abstraction layer for a particular device, etc.). The device applications 418 also include any system components or modules to implement embodiments of publishing client device usage data. In this example, the device applications 418 include a data service 422 and a Web service 424 when device 400 is implemented as a server device or service layer. The data service 422 and the Web service 424 are shown as software modules and/or computer applications. Alternatively or in addition, the data service 422 and the Web service 424 can be implemented as hardware, software, firmware, or any combination thereof.

Device 400 also includes an audio and/or video input-output system 426 that provides audio data to an audio system 428 and/or provides video data to a display system 430. The audio system 428 and/or the display system 430 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, the audio system 428 and/or the display system 430 are implemented as external components to device 400. Alternatively, the audio system 428 and/or the display system 430 are implemented as integrated components of example device 400.

Although embodiments of publishing client device usage data have been described in language specific to features and/or methods, it is to be understood that the subject of the appended claims is not necessarily limited to the specific features or methods described. Rather, the specific features and methods are disclosed as example implementations of publishing client device usage data.

1. A computer-implemented method, comprising:
receiving usage data that corresponds to one or more device applications on a client device when the one or more device applications are used at the client device;
receiving a request for the usage data from a requesting client device;
generating a portable code module that includes the usage data; and
communicating the portable code module that includes the usage data to the requesting client device that executes the portable code module to display the usage data.

2. A method as recited in claim 1, further comprising filtering the usage data based on user preferences that are associated with the client device, and wherein the portable code module is generated to include filtered usage data.

3. A method as recited in claim 1, wherein types of the usage data that is received are specified by user preferences that are associated with the client device.

4. A method as recited in claim 1, wherein the usage data that is received includes identification of users that are permitted to request access to the usage data.

5. A method as recited in claim 1, further comprising:
generating a Web page that includes the portable code module; and
communicating the Web page that includes the portable code module to the requesting client device for display of the Web page.

6. A method as recited in claim 1, wherein the usage data that corresponds to the one or more device applications pertains to at least one of:
a Web page displayed for viewing at the client device;
media content played back at the client device;
an instant messaging session initiated at the client device;
a current location of the client device; or
an on-line presence of a user that is associated with the client device.

7. A method as recited in claim 1, further comprising encapsulating the usage data as a Web service response and communicating the usage data to a Web service that generates the portable code module.

8. A system, comprising:
at least a memory and a processor that implement a data service configured to receive usage data that corresponds to one or more device applications on a client device when the one or more device applications are used at the client device;
the memory and the processor further implement a Web service for publishing the usage data, the Web service configured to:
receive a request for the usage data from a requesting client device;
generate a portable code module that includes the usage data; and
communicate the portable code module that includes the usage data to the requesting client device that is configured to execute the portable code module to display the usage data.

9. A system as recited in claim 8, wherein the data service is further configured to filter the usage data based on user preferences that are associated with the client device, and wherein the Web service is further configured to generate the portable code module to include filtered usage data.

10. A system as recited in claim 8, wherein types of the usage data that is received are specified by user preferences that are associated with the client device.

11. A system as recited in claim 8, wherein the usage data that is received includes identification of users that are permitted to request access to the usage data.

12. A system as recited in claim 8, wherein the Web service is further configured to:
generate a Web page that includes the portable code module; and
communicate the Web page that includes the portable code module to the requesting client device for display of the Web page.

13. A system as recited in claim 8, wherein the usage data that corresponds to the one or more device applications pertains to at least one of:
a Web page displayed for viewing at the client device;
media content played back at the client device;
an instant messaging session initiated at the client device;
a current location of the client device; or
an on-line presence of a user that is associated with the client device.

14. A system as recited in claim 8, wherein the data service is further configured to encapsulate the usage data as a Web service response and communicate the usage data to the Web service that generates the portable code module.

15. Computer-readable media having stored thereon computer-executable instructions that, when executed by a server system, initiate the server system to:
receive usage data that corresponds to one or more device applications on a client device when the one or more device applications are used at the client device;
receive a request for the usage data from a requesting client device;
generate a portable code module that includes the usage data; and
communicate the portable code module that includes the usage data to the requesting client device that executes the portable code module to display the usage data.

16. Computer-readable media as recited in claim 15, wherein the computer-executable instructions, when executed, further initiate the server system to filter the usage data based on user preferences that are associated with the client device, and generate the portable code module to include filtered usage data.

17. Computer-readable media as recited in claim 15, wherein the computer-executable instructions, when executed, further initiate the server system to receive types of the usage data that are specified by user preferences that are associated with the client device.

18. Computer-readable media as recited in claim 15, wherein the computer-executable instructions, when executed, further initiate the server system to receive the usage data that includes identification of users that are permitted to request access to the usage data.

19. Computer-readable media as recited in claim 15, wherein the computer-executable instructions, when executed, further initiate the server system to:
generate a Web page that includes the portable code module; and
communicate the Web page that includes the portable code module to the requesting client device for display of the Web page.

20. Computer-readable media as recited in claim 15, wherein the usage data that corresponds to the one or more device applications pertains to at least one of:
a Web page displayed for viewing at the client device;
media content played back at the client device;
an instant messaging session initiated at the client device;
a current location of the client device; or
an on-line presence of a user that is associated with the client device.
